(19) United States
(12) Patent Application Publication
(10) Pub. No.: US 2019/0321745 A1
(43) Pub. Date: Oct. 24, 2019

(54) Column for the exchange of material and/OR heat between a gas and a liquid with means for recirculating the liquid

(71) Applicants: PROSERNAT, PU-TEAUX (FR); TOTAL SA, Courbevoie (FR); IFP ENERGIES NOUVELLES, Rueil-Malmaison Cedex (FR)

(72) Inventors: Gauthier PERDU, Suresnes (FR); Clement SALAIS, Paris (FR); Xavier COURTIAL, Puteaux (FR); Vincent CARLIER, Lyon (FR); Claire WEISS, Vaucresson (FR); Thomas MAUBERT, Pau (FR); Manel FOURATI, Venissieux (FR); Philippe BEARD, Saint Genis-Laval (FR); Pascal ALIX, Roussillon (FR)

(73) Assignees: AXENS, Rueil-Malmaison (FR); TOTAL SA, Courbevoie (FR); IFP ENERGIES NOUVELLES, Rueil-Malmaison Cedex (FR)

(21) Appl. No.: 16/470,672

(22) PCT Filed: Dec. 15, 2017
(86) PCT No.: PCT/EP2017/083072

§ 371 Date: Jun. 18, 2019

(30) Foreign Application Priority Data
Dec. 19, 2016 (FR) 1662742

(51) Int. Cl. B01D 3/00; B01D 3/42; B01D 53/18; B01D 53/14

(52) U.S. Cl. CPC B01D 3/008; B01D 3/4211; B01D 53/185; B01D 2257/308; B01D 2257/504; B01D 2257/304; B01D 53/1406

(57) ABSTRACT

The present invention relates to a column (CO) for the exchange of material and, if appropriate, heat between a gas and a liquid. The exchange column (CO) comprises at least one collector tray and a system for distributing liquid arranged between two packing beds (7), and means for recirculating the liquid (8). The means for recirculating the liquid (8) connect a zone situated below the packing bed (7) to a zone situated above the distributor tray.

The present invention relates to the field of gas/liquid contact columns. The fields of applications of the invention can be the treatment of gas, the capture of CO₂, dehydration, the separation of contaminants present in gaseous flows by means of a liquid solution, or also the distillation of liquid compounds in a mixture.

The industry uses a large number of gas/liquid contactors (contact columns). The latter can be used for the separation of products, such as distillation processes, or also the absorption of contaminants, such as the amine treatment processes, in the gas treatment and/or CO₂ capture sector. When it is a question of removing contaminants present in the gas, such as CO₂, water, H₂S, COS by processes of washing with a liquid, vertical contactors which wash an ascending gas flow circulating in counter-current to a descending liquid flow are generally used. Thus, the contaminants of the gas are retained by the liquid when the gas rises in the column, with variable absorption rates. By “vertical contactors” is also meant regeneration towers in which the (liquid) solvents loaded with contaminants are purified by contact with a gas, which promotes the extraction of the contaminants present in the solution loaded with contaminants.

A wide variety of types of gas/liquid contactors exists. Conventionally, vertical contactors can contain contact internals of the random packing and/or structured packing type, and utilize several packing beds with intermediate redistribution of the liquid flows, as shown schematically in FIG. 1. For example, for the case of absorption of acidic gases by an aqueous solution of amine(s), it is possible to use a gas/liquid contact column CO containing packing, divided into several packing beds 7. The contact column CO receives the gaseous fluid to be treated at the bottom of the column FA, and the lean (liquid) solvent at the top of the column SP. The gaseous fluid to be treated is generally introduced at the bottom of the contact column using a gaseous distributor 13 allowing the ascending vapour phase velocity profile onto the entire lower packing section to be as uniform as possible, in order to improve the operating performance of the contactor. The contact column CO delivers the treated gaseous fluid FT, purified of a part of the contaminants, at the top of the column and the rich solvent SR, loaded with a part of the contaminants contained in the gaseous fluid to be treated, at the bottom of the column. The transfer of the contaminants from the gaseous fluid to the liquid solvent is carried out via bringing the descending liquid phase into intimate contact with the ascending vapour phase within the contactor, at the level of the packing beds 7. The packing beds 7 are composed of solid elements that have a high contact surface over which the liquid is uniformly distributed and flows downwards, which promotes contact with the ascending vapour phase, and thus makes it possible to effectively transfer material and/or heat between the two fluids.

Two major families of packings are currently available. A first type of packing is constituted by a multiplicity of singular solid elements, possibly identical and generally of a moderate size (of the order of a centimetre) arranged at random within the contactors, hence the name “random packing”. The second type of packing, called “structured packing”, is generally formed by steel sheets, shaped and arranged in a particular manner.

For all the types of packing, in order to have available the entire surface developed by the internal transfer, each of the flows developing in counter current flows as uniformly as possible over the entire section of the column, and of the contact internals of the column. For this purpose, the lean solvent SP at the top of the column is uniformly injected over the top packing bed section 7, using a liquid distributor 14. Generally, the constituent elements of the packing beds make it possible to form and/or to maintain a homogeneous and uniform distribution of the fluids over the entire contact section. However, when a high level of contact is required, it is preferable to resort to a plurality of packing beds 7 and a plurality of associated systems for redistributing liquid. In fact, when a liquid passes within a packing, the latter tends to progressively accumulate in certain preferential passage zones, and the uniformity of the distribution is degraded, until local velocity gradients are generated for the gas and liquid phases, thus degrading the performance of contacts between the liquid and gaseous flows and the overall efficiency of the column. This phenomenon can be amplified in the case of use under “offshore floating” conditions. It then becomes preferable to further shorten the packing bed and dedicate a part of the column to the installation of devices for collecting and redistributing the liquid. The aim is to allow the most homogeneous possible redistribution of the liquid flow over the surface of the lower packing bed 7.

The Fractionation Research Inc. (FRI) advises limiting the height of a packing bed to a height of eight metres and mixing the liquid phase again before reintroducing it over a lower packing section (reference FRI, Fractionation Tray Design Handbook, vol. 5: Design Practices). This maximum height can vary depending on the case, and depends on numerous parameters which can be: operating conditions and flow rates, external disturbances to the exchange column such as the forces of movements on the columns installed on floating supports, such as barges and production vessels, the type of packing, the properties of the fluids, operational conditions etc. The segmentation of the contact zone into several packing beds 7 can then require the utilization of systems for redistributing liquid 5, connected to collecting trays 1. These are installed between two packing beds, i.e. in the case of this illustrated example, above the intermediate and lower packing beds 7.

Among the systems for redistributing liquid installed between two successive packing beds, two types of systems are used to collect the liquid originating from the upper packing bed and redistribute it to the lower packing bed.

A first type of system uses a single device making it possible both to collect the liquid originating from the upper packing bed, and to redistribute it over the lower packing bed while allowing the passage of the gas phase, generally using chimneys. These are generally simple and economical systems, but they do not promote the mixing of the liquid phase collected from the upper packing bed, because the circulation of the liquid collected on the tray remains transversal to the column. There are three distinct major families within this type of system:
Liquid distributors with gas chimneys: A liquid guard is established over the entire section of the distributor tray and feeds the contact (packing) bed via orifices uniformly distributed over the bottom of the tray. The gas is conveyed via chimneys (e.g. US 2013/0277868A). FIG. 2 shows a distributor tray 1 with standard chimneys, provided with chimneys 2 for the gas to pass through, the chimneys being covered by “caps” 3 to prevent liquid from passing within the gas chimneys (in a counter-current flow situation), and orifices 4 for the liquid to pass through.
Liquid distributors with liquid boxes: A liquid guard is established over an assembly of boxes provided with feed orifices, and the gas is conveyed via the remaining space (e.g. U.S. Pat. No. 4,909,967A).
Liquid distributors with liquid chimneys: these distributors operate according to the same principle as the distributor with gas chimneys. The difference is that the liquid is distributed via chimneys that can have orifices situated at several different heights, thus making it possible to pass a larger range of flow rates through than in the case of simple orifices in the bottom of the tray. The gas is conveyed thereto via chimneys that can be in the shape of a cylinder or parallelepiped (e.g. U.S. Pat. No. 5,132,055A, U.S. Pat. No. 4,432,913).

A second type of system uses separate devices to collect the liquid originating from the upper packing bed, and to redistribute it over the lower packing bed, the liquid being transmitted from one system to the other via liquid transfer pipes, otherwise called “liquid transfer legs” by a person skilled in the art; the passage of the vapour phase commonly being achieved using chimneys. These are generally robust systems that promote the mixing of the liquid phase because the liquid is collected at a few very localized points. Within this type of system, the collecting part should be separated from the distributing part. The document “Process Engineering Guide: GBHE-PEG-MAS-612 Design and Rating of Packed Distillation Columns” in particular illustrates these different systems.

The devices for collecting liquid are generally differentiated by the means making it possible for the vapour flow to pass from the lower bed to the upper bed:
collector trays with circular gas chimneys, provided with covers also called “caps” by a person skilled in the art,
collector trays with rectangular gas chimneys, provided with caps, or
collector trays with rectangular gas chimneys of the trough type.

Of this second type of distributor, the devices for distributing liquid are generally divided into four distinct sub-families:
“through distributors”, rather compact but requiring perfect horizontal alignment (not recommended in the case of critical services and under offshore floating and oscillating conditions, i.e. at sea),
“orifice riser type distributor”, rather compact but reserved for columns with a small diameter (less than 1 m), requiring perfect horizontal alignment: the non-uniformities of distribution are generally significant (not recommended in the case of critical services and under offshore floating and oscillating conditions),
“perforated piping distributor”, not very compact, exhibiting a greater driving force than the previous distributors and thus requiring a generally greater static height of liquid above the distributor, but generally delivering a uniform distribution of the liquid including under offshore and oscillating conditions or,
“spray distributors”, not very compact, requiring, like the previous distributor, a significant static height (a pump can also be used to ensure the distribution force). The distribution uniformity performance is more moderate over the liquid (due to the creation of zones covering the liquid cones). The impact of the droplets on the packing is significant for dispersing the liquid force and the system is very highly prone to liquid entrainment by creation of a mist of droplets.

FIG. 3 shows an example of the latter type of systems which dissociates the collection of the liquid from its distribution. The collector tray 1 comprises chimneys 2 for the gas to pass through. The system for distributing the liquid comprises a vertical pipe 5 and a plurality of sprinklers 6 (horizontal tubes provided with orifices or nozzles).

For offshore floating conditions, it is generally this type of system illustrated in FIG. 3, ensuring the collection and redistribution of the liquid between two packing beds, which is preferred for two reasons: 1—the effects of the oscillations of the liquid in the central leg are minimized, and 2—a uniform distribution towards the lower bed is sought. Thus, the liquid collector tray is connected to the distribution system by one or more relatively long vertical pipes in order that the distributor system creates sufficient static height, irrespective of the tilting conditions due to the swell and provides the driving force to the distributor. In fact, the vertical pipe is dimensioned in such a way that the variation in the height of liquid due to a lack of horizontal alignment is far less than the height of the pipe of liquid feeding the distribution system (US 2004/0020238 A1). In this case, the system for distributing liquid can be formed by one or more sprinklers, and the gas is conveyed via chimneys situated at the level of the collector tray.

The counter-current gas/liquid contact columns equipped with packing beds and installed on a floating support are disturbed by a change in the circulation of the liquid due to the movement of the column deviating from the vertical position. Neither is the distribution of the liquid uniform, which adds to the progressive deformation of the uniformity of distribution of the liquid when the liquid progresses through a packing bed. Liquid distribution profiles are obtained, the heterogeneity of which increases, which then disturbs the distribution of the gas which will be distributed non-uniformly as a function of the poor distribution of liquid. In very wet zones, the gas may try and avoid the liquid. The loss of efficiency of the column results from the intersection of significant gas flow rates with low liquid flow rates in zones with a low circulation of liquid. In order to tackle the loss of efficiency of the column, the engineers responsible for dimensioning increase the liquid flow rate and/or the height of the packing beds, so as to achieve a successful purification performance. Increasing the liquid flow rate requires a column of more consistent size, with greater regeneration. By increasing not only the size of the absorber, but optionally also that of the regeneration section, the mass of the equipment composing the workshops present on the barge or the floating platform, and thus the price of the project, are increased.

The designers of natural gas purification columns must also respond to the problems of operational versatility required for numerous cases of operation, in particular for the liquid. In fact, for the dimensioning, the designers must consider the highest feed gas flow rate associated with the highest contaminant concentrations. This dimensioning requires the highest absorbent liquid solution flow rate for absorbing a maximum quantity of contaminants. Now, other cases of operation require lower and minimum operating conditions (in terms of flow rate and quantity of contaminants present in the gas to be purified), which in particular defines a “turndown” case (minimum technical operation or low flow rate) or “lean” cases. In this case, the liquid flow rate adopted for operation is lower.

Since the height of liquid constitutes the driving force for the distribution of the liquid through the orifices, the minimum liquid flow rate imposes the minimum height of the vertical pipe (as well as the diameter) which distributes the liquid uniformly through the orifices, for example on the device of FIG. 3. The variability of the liquid flow rate requires other dimensions of the collectors but must be freed from the means for distributing the liquid previously defined for the “turndown” (low flow rate) case, and then distributes the higher liquid flow rates uniformly with a height of the vertical pipe of a greater height in order to increase the driving force necessary for the removal of a higher flow rate. A device is then available that is capable of distributing the variability of the liquid flow rates with relatively long vertical pipes, but the need to install the longer vertical pipes increases the total height of the columns, as well as the weight of the equipment of the workshops on the FLNG facility or the floating support. On oscillating columns, the model additionally requires a vertical pipe with a sufficient height that must maintain a homogeneous and uniform distribution over the entire range of flow rates when the column tilts, thanks to a sufficient static height, and being well positioned in the centre of the column. The variability of the liquid flow rate requires a variable filling of the system for distributing liquid, taking into consideration all the cases studied, in particular the “turndown” case with low liquid flow rate (and minimum filling) and the case of dimensioning with high liquid flow rate (and maximum filling). For example, for the distribution system according to FIG. 3, the vertical pipe must then have a minimum height of from 2.5 to 3.5 metres, which is repeated between each bed. An additional height of 6 to 9 metres of the column is then required in order to implement this configuration if a column with three to four beds is considered.

The present invention relates to a column for the exchange of material and, if appropriate, of heat between a gas and a liquid. The exchange column comprises at least one collector tray and a system for distributing liquid arranged between two packing beds, and means for recirculating the liquid. The means for recirculating the liquid connect a zone situated below the packing bed to a zone situated above the distributor tray. The means for recirculating the liquid make it possible to increase the efficiency of the column due to a better wetting rate. In addition, the means for recirculating the liquid make it possible to limit the variability of the liquid flow rate, which makes it possible to reduce the height of the means for distributing the liquid.

### THE DEVICE ACCORDING TO THE INVENTION

The invention relates to a column for the exchange of material and/or heat between a gas and a liquid comprising at least one packing bed, at least one collector tray arranged above said packing bed, and means for distributing said liquid over said packing bed. Said column is equipped with means for recirculating the liquid from a zone situated below said packing bed to a zone situated above said collector tray.

According to an embodiment of the invention, said means for recirculating said liquid comprise at least one pump.

According to an implementation, said means for recirculating said liquid comprise at least one heat exchanger for cooling or heating said liquid.

According to a characteristic, said column is coupled to means for regenerating said liquid.

Preferably, said means for regenerating said liquid are arranged in order to regenerate a portion of said liquid from said means for recirculating liquid.

Advantageously, the flow rate of said liquid in said means for regenerating said liquid is comprised between 20 and 200% of the flow rate of said liquid entering said column.

According to an embodiment, said means for recirculating the liquid collect said liquid from the bottom of said column.

According to an implementation, said column comprises a plurality of packing beds, a plurality of collector trays, and a plurality of distribution means.

Advantageously, said means for recirculating said liquid collect said liquid in a zone situated between two packing beds.

Preferably, said means for recirculating said liquid convey said liquid in a zone situated between two packing beds.

According to an embodiment, said means for recirculating said liquid distribute said liquid at the top of said column.

According to an optional embodiment, said means for recirculating said liquid comprise a flash drum for partially regenerating said liquid.

According to an implementation, said distribution means comprise at least one vertical feed pipe connected to said collector tray, and at least one substantially horizontal tube connected to said feed pipe (5), said horizontal tube (5) comprising at least one orifice and/or one nozzle for the distribution of said liquid.

Moreover, the invention relates to a use of a column according to one of the previous characteristics for a process for the treatment of gas, capture of acidic gases, distillation, dehydration or separation of air.

Furthermore, the invention relates to a use of a column according to one of the previous characteristics for a process for the treatment of a gas specifically comprising COS in addition to CO₂ and H₂S.

### BRIEF PRESENTATION OF THE FIGURES

Other characteristics and advantages of the device according to the invention will become apparent on reading the following description of non-limitative embodiment examples, with reference to the attached figures which are described below.

FIG. 1, already described, shows the layout of a gas/liquid contactor containing packing, operating in counter-current and utilizing several packing beds with intermediate redistribution of the liquid flow, according to the prior art.

FIG. 2, already described, shows a collector tray with chimneys according to the state of the art.

FIG. 3, already described, shows a collector tray equipped with a distribution system, connected by a liquid transfer pipe, according to the state of the art.

FIGS. 4 to 9 describe different embodiments of the column according to the invention.

FIGS. 10a, 10b and 10c describe a tilted column according to the prior art with a low flow rate, according to the state of the art with a high flow rate, and according to the invention with a high flow rate respectively.

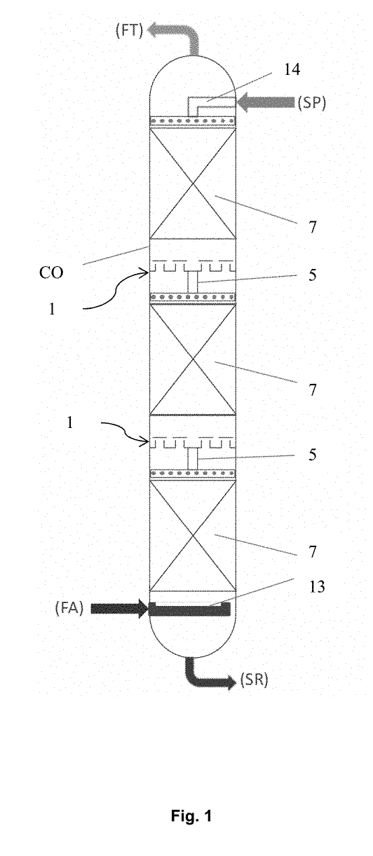

### DETAILED DESCRIPTION OF THE INVENTION

The present invention relates to a column for the exchange of material and possibly of heat between a gas and a liquid (also called a contact column). According to the invention, the exchange column comprises at least one packing bed. The term “packing bed” refers to a section of packing which is distributed over a certain height of the column. The packing can be random packing or structured packing. The packing corresponds to a contactor and allows the liquid and gas to be brought into contact in order to allow exchanges of heat and/or material between the fluids.

According to the invention the exchange column comprises at least one system for redistributing liquid comprising a collector tray, and means for distributing the liquid. Each system for redistributing the liquid is arranged between two packing beds, in a zone called the “inter-bed zone”. The collector tray collects the liquid on its upper surface, and allows the gas to pass through the tray. The passage of the gas through the tray can in particular be carried out by means of chimneys equipped, or not equipped, with caps. In fact, when a liquid passes within a packing, the latter tends to progressively accumulate in certain preferential passage zones, generating local velocity gradients for the gas and liquid phases, thus degrading the performances of contact between the liquid and gaseous flows and the overall efficiency of the column. This phenomenon can be amplified in the case of use under “offshore floating” conditions. When a high level of contact is required, it becomes preferable to resort to a plurality of packing beds and a plurality of devices for collecting and distributing the liquid. In this case, it is advantageous to redistribute the liquid flow over the surface of the lower packing as homogeneously and uniformly as possible. It generally becomes preferable to use collectors/redistributors of liquid between two sections of packing, beyond a packing height of eight metres (maximum height recommended by the FRI). This maximum recommended height can be modified (generally reduced) depending on the working conditions (offshore floating, type of packing, fluid properties, operating conditions etc.) in order to limit the amplitude of the maldistribution on leaving the packing bed.

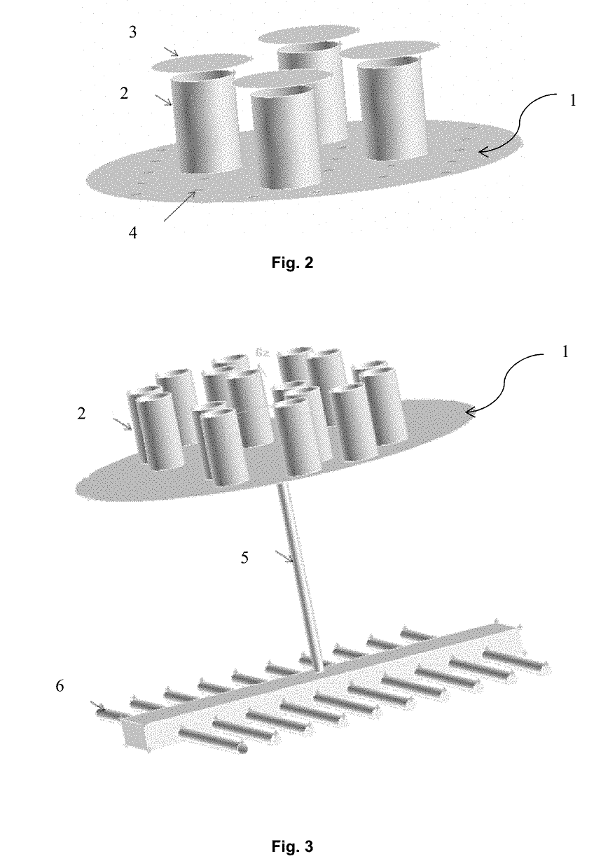

The means for distributing the liquid make it possible to distribute, homogeneously, the liquid collected by the collector tray over the packing bed situated directly below. Thus, the liquid flows by gravity from an upper packing bed, through the collector tray and distribution means, in order to be distributed over a lower packing bed. The distribution means can be of any type. For example, they can be in the form of orifices formed in the collector tray, as described in FIG. 2. As a variant, the means for distributing the liquid are situated below the collector tray in the inter-bed zone, and are connected to the collector tray for the liquid to pass through. The distribution means can be of any known form, in particular that shown in FIG. 3 (tubular distributor with orifices). According to an embodiment of the invention (which can be combined with the different variants described below), the distribution means comprise at least one vertical feed pipe connected to the collector tray, and to the at least one, preferably a plurality of, substantially horizontal tube(s) connected to the vertical feed pipe. Each horizontal tube is equipped with at least one orifice and/or one nozzle for distributing the liquid. Alternatively, the distribution means can be spray distribution means (with nozzles) or trough distribution means. The means for distributing the liquid allow good distribution of the liquid over the lower packing bed, including under offshore floating conditions (at sea), for which the column can be tilted with respect to the vertical.

The column according to the invention is equipped with means for recirculating the liquid, these means for recirculating the liquid make it possible to return the liquid to the column. The means for recirculating the liquid collect a part of the liquid from at least one zone situated below a packing bed and distribute at least a portion of the collected liquid in at least one upper zone situated above a collector tray, where the recirculating liquid is combined with the internal liquid flow of the column. Thus, the recirculation means make it possible to collect the liquid from at least one zone, and to put it into circulation, and to reinject the liquid into the column at at least one higher level. In this way, the liquid flow rate is increased in the packing, which makes it possible to increase the wetting rate, and thus to limit the efficiency losses due to the maldistribution of liquid and thus the efficiency of the exchanges of material and/or heat between the gas and the liquid. The means for recirculating liquid make it possible to recirculate a liquid that is partially loaded with CO₂ and/or H₂S contaminants (having previously exchanged with the gas) and non-regenerated or partially regenerated from the contaminants that it contains. The recirculation liquid can pass through a single packing bed in order to increase the flow rate over a limited height, or a plurality of packing beds in order to increase the flow rate over a significant height, or even over the entire height of the exchange column. Furthermore, recycling the (liquid) solvent proves useful because, after a first exchange in the packing bed, the solvent retains a capacity to absorb contaminants, in particular because the maldistribution operating in the packing bed has reduced the efficiency of the column. Therefore, the overall absorption rate, and thus the yield of the column is improved. In particular, the recirculation of the solvent improves the absorption of the constituents that are the slowest to be absorbed (such as COS) by correcting the inefficiencies of the column and bringing a greater, thus more reactive, quantity of liquid into contact with the gas that is contaminated (with COS).

Furthermore, for the embodiment for which the distribution means comprise at least one vertical pipe and at least one tube (cf. FIG. 3), the means for recirculating the liquid make it possible to reduce the height of the vertical pipe, with respect to the solutions without recirculation of liquid. In fact, the recirculation means limit the variability of the liquid flow rate between the cases of low flow rates of the “turndown” type, and the cases of higher flow rates of the maximum or design type, which makes it possible to reduce the difference between the minimum height and the maximum height of liquid to be taken into account for dimensioning the length of the vertical pipe. Thus, it is possible to reduce the height of the vertical pipe of the redistribution device and thus the overall height of the column by limiting the versatility requirements of the liquid distributors with respect to the variability of the flow rates of operation. According to an embodiment of the invention, the advantage of limiting the length of the vertical pipe permitted by the invention is even greater if the recirculation is provided by a column positioned on a floating support, for two reasons: 1—the tilting of the liquid in the collection and distribution system oscillating as a function of the swell increases the length requirement of the vertical pipe as a function of the variability of the flow rates, and 2—due to the oscillating conditions of the floating unit, the maldistribution is greater on an offshore floating column and the solvent collected has a greater additional absorption potential if it is recirculated. The implementation of the invention reduces both the variability of the flow rates and thus the length of the vertical pipe by a greater factor and improves the performance of the column.

According to an embodiment of the invention, the means for recirculating the liquid comprise a pump. The pump allows the recirculation of the liquid to a higher level of the column, and can also make it possible to adjust the liquid flow rate. Moreover, the means for recirculating the liquid can comprise a collection system that makes it possible to feed the pump, and a system for mixing and distribution to an upper level. The means for recirculating the liquid are preferentially arranged outside the exchange column.

According to an implementation of the invention, the means for recirculating the liquid can also comprise a cooler. The cooler makes it possible to cool the liquid being recirculated before it is reinjected into the column. Thus, it is possible to increase the liquid absorption performance. In fact, low temperatures generally increase the absorption capacity of liquids, which makes it possible to increase the efficiency of the exchange column, provided that the reaction kinetics are not too affected.

Alternatively, the means for recirculating liquid can comprise heating means. The heating means make it possible to heat the recirculating liquid before it is reinjected into the column. These heating means can advantageously be situated, for heating the injected recycled liquid, at the top of the column or in inter-packing bed zones. In fact, higher temperatures generally increase the rate of absorption of the contaminants into the liquids because the chemical reactions that participate in the absorption are accelerated by rising temperatures, making it possible to increase the efficiency of the exchange column, if the absorption capacity is not too affected. Thus, it is possible to increase the performance of absorption of certain contaminants such as CO₂ or COS when they are present.

According to a particular design, the collection of liquid for the means for recirculating liquid can be carried out at the bottom of the column, i.e. at the base of the column, below the last packing bed of the column passed through by the liquid. Thus, the fluid is collected at the column outlet, and it is not necessary to provide additional collecting means for the recirculation.

According to an embodiment option, when the exchange column comprises a plurality of packing beds, the collection of liquid for the means for recirculating liquid can be carried out in an inter-bed zone, i.e. between two packing beds. In this case, the collection of the liquid can be carried out between the packing bed and the collector tray situated directly below the packing bed or advantageously benefit from the arrangement of the latter which adds a draw-off of liquid into the device.

According to an embodiment, the reinjection of liquid by the means for recirculating liquid can be carried out at the head of the column, i.e. at the top of the column, above the first packing bed of the column passed through by the liquid. Thus, the liquid flow rate is increased for the entire height of the exchange column.

As a variant and when the exchange column comprises a plurality of packing beds, the reinjection of liquid by the means for recirculating liquid can be carried out into an inter-bed zone, i.e. between two packing beds. In this case, the reinjection of the liquid can be carried out advantageously between the collector tray and the packing bed situated directly above the collector tray. Thus, the liquid flow rate is increased without increasing the total height of the exchange column.

Advantageously, the flow rate of liquid in the means for recirculating liquid can be comprised between 20 and 200% of the flow rate of liquid circulating in the column in the absence of recirculation. Thus, the flow rate of liquid in the packing bed is significantly increased, thus increasing the efficiency of the exchanges between the liquid and the gas.

According to an embodiment of the invention, the column can be equipped with means for regenerating the liquid. The means for regenerating the liquid make it possible to regenerate the loaded liquid (i.e. having exchanged with the gas) collected at the bottom of the column: in other words the means for regenerating the liquid make it possible to separate the liquid and the loads exchanged with the gas. Then the regeneration means make it possible to reinject the unloaded liquid, purified of the contaminants, at the top of the column. Thus, the liquid leaving the column can be reused, after regeneration, in order to carry out, continuously in a closed circuit, exchanges of heat and/or material with the gas to be treated. For example, if the column is an amine washing column, the liquid used is a solvent comprising amines. This liquid absorbs molecules originating from the gas, for example CO₂, COS and/or H₂S, by contact with the gas in the packing beds. After passing through the packing beds, the solvent is collected at the bottom of the column in order to be regenerated, i.e. separated from the CO₂, COS and/or H₂S, then to be reinjected at the top of the column. The load, i.e. the CO₂, COS and H₂S, is removed from the regeneration means via another outlet. In the case of an amine absorbent solution, the regeneration can consist of heating the solvent, generally under moderate pressure (a few bar). The regeneration can be implemented by at least one regeneration column and by heating means (means for bringing the solvent to the boil). The regenerated solvent, i.e. with a reduced load of contaminants, is suitable for again exchanging material and/or heat with the gas. The solvent then has a greater absorption capacity, which is greater than that of the non-regenerated solvent at the same temperature.

According to a variant of the invention, the means for regenerating the liquid are independent of the means for recirculating the liquid.

Alternatively, the means for regenerating the liquid are arranged for regenerating a part of the liquid circulating in the means for recirculating the liquid. Thus, the liquid at the bottom of the column is separated into two portions: a first recycled portion (without regeneration) reinjected into the column, and a second portion passing through the equipment for regenerating the loaded solvent before being reinjected at the top of the column. This design can be useful for reducing the dimensioning of the regeneration means by limiting the flow rate to be treated in the regeneration and reducing the requirements for heating.

According to an advantageous embodiment of the invention within the context of exchanges of material between the liquid and the gas, the means for recirculating the liquid comprise a flash drum, suitable for partially separating the liquid from its gaseous load by an expansion (reduction in pressure with respect to the exchange column). In the processes of absorption of the contaminants from the natural gas, the pressure in the column for absorption of the contaminants H₂S, COS and CO₂ is high, but the pressure in the flash drum is an average pressure. In fact, the reduction of the pressure in the flash drum makes it possible to partially regenerate the loaded liquid by the effect of expansion of the liquid between the higher pressure in the absorber and the lower pressure in this flash drum. This embodiment allows a better efficiency of the column, by recirculating a liquid partially unloaded of its contaminants, which increases the absorption capacity of the column in operation.

A variant of this embodiment can consist of associating a flash drum in the recirculation circuit with regeneration means. At the outlet from the flash drum, the liquid can be separated into two portions, a first portion of which is recycled without regeneration in the column, and the second portion of which is regenerated before being reintroduced at the top of the column. It is considered that the pressure in the exchange column is a high pressure, that the pressure in the flash drum is an average pressure, and that the pressure in the regeneration means is a low pressure. This method can be advantageously applied in order to limit the height of the columns negatively affected by significant variabilities in the liquid flow rate between the maximum necessary flow rate and the minimum necessary flow rate, such as columns installed on a floating support or FLNG facility.

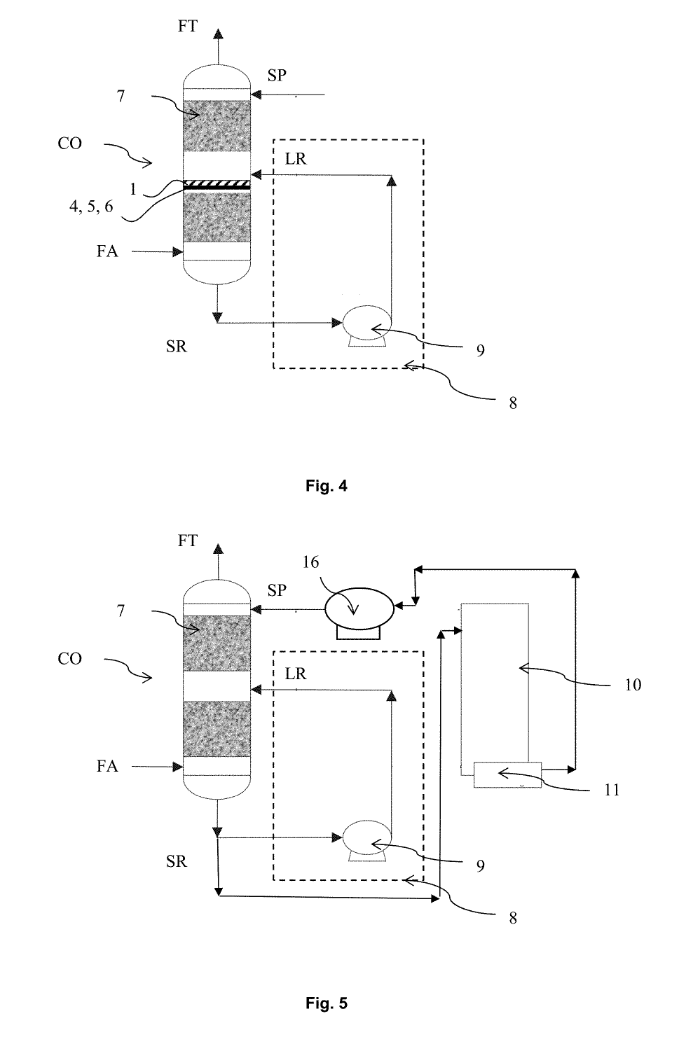

FIGS. 4 to 9 show diagrammatically and non-limitatively, an exchange column according to different embodiments of the invention. In these figures, and except for FIG. 4, the collector tray and the distribution means located between the packing beds are not shown for the sake of simplification. However, the collector tray and the distribution means located between the packing beds can be produced according to any known design, for example that shown in FIG. 3. FIGS. 4 to 9 show exchange columns with two packing beds; however this number of packing beds is not limitative. Each exchange column can comprise one or more packing beds, for example between one and six packing beds, and preferably two, three or four packing beds.

FIG. 4 shows an exchange column CO comprising two packing beds 7. A gaseous fluid to be treated FA is introduced at the bottom of the exchange column CO, and the treated gaseous fluid FT is removed at the top of the exchange column CO. A liquid SP (for example a lean solvent within the context of an amine washing column) is injected at the top of the exchange column CO, and the liquid SR (rich solvent for the example of solvent) is removed at the bottom of the exchange column CO. The exchange column CO is equipped with means for recirculating the liquid 8. The means for recirculating the liquid 8 collect the liquid SR at the bottom of the column, and reinject the recycled liquid LR into a zone between the packing beds, also called inter-packing bed zone (space separating the two packing beds 7). In particular, the recycled liquid LR is sent to the area above the collector tray 1 overlying the lower packing bed. In the inter-packing bed zone, the recycled liquid LR is mixed with the liquid descending from the upper packing bed. The mixture thus obtained is distributed by the distribution means (4, 5, 6) on the lower packing bed. The means for recirculating the liquid 8 comprise a pump 9 for circulating the liquid. The flow rate of recycled liquid can be comprised between 20 and 200% of the flow rate of liquid sent for regeneration.

FIG. 5 shows an exchange column CO comprising two packing beds 7. A gaseous fluid to be treated FA is introduced at the bottom of the exchange column CO, and the treated gaseous fluid FT is removed at the top of the exchange column CO. A liquid SP (for example a lean solvent within the context of an amine washing column) is injected at the top of the exchange column CO, and the liquid SR (rich solvent for the example of solvent) is removed at the bottom of the exchange column CO. The exchange column CO is equipped with means for recirculating the liquid 8. The means for recirculating the liquid 8 collect the liquid SR at the bottom of the column, and reinject the recycled liquid LR into an inter-packing bed zone (space between the two packing beds 7). In the inter-packing bed zone, the recycled liquid LR is mixed with the liquid descending from the upper packing bed. The means for recirculating the liquid 8 comprise a pump 9 for circulating the liquid. In addition, the exchange column CO is coupled to the means for regenerating the liquid. The means for regenerating the liquid comprise a regeneration column 10, reboiling means 11, and a pump 16. The means for regenerating the liquid are arranged for regenerating a portion of the liquid leaving the bottom of the column CO: at the base of the column, the liquid is separated into two branches, a first branch for recycling into the inter-packing bed zone (via the recirculation means 8), and the second for regeneration in the regeneration column 10. At the outlet of the regeneration column 10, the liquid SP found at the bottom of the regeneration column 10 and/or at the liquid outlet from the reboiling means 11, is injected at the top of the exchange column CO, for example by means of a pump 16. The flow rate of recycled liquid can be comprised between 20 and 200% of the flow rate of liquid sent for regeneration. The separation between the two flows of liquid can be carried out independently before or after the pump 9.

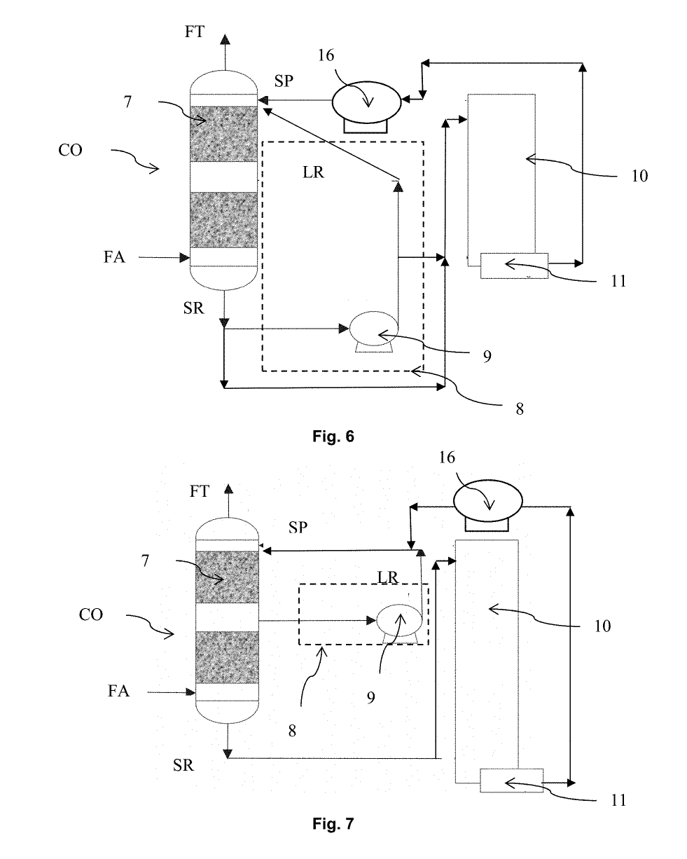

FIG. 6 shows an exchange column CO comprising two packing beds 7. A gaseous fluid to be treated FA is introduced at the bottom of the exchange column CO, and the treated gaseous fluid FT is removed at the top of the exchange column CO. A liquid SP (for example a lean solvent within the context of an amine washing column) is injected at the top of the exchange column CO, and the liquid SR (rich solvent for the example of solvent) is removed at the bottom of the exchange column CO. The exchange column CO is equipped with means for recirculating the liquid 8. The means for recirculating the liquid 8 collect the liquid SR at the bottom of the column, and reinject the recycled liquid LR at the top of the exchange column CO, above the upper packing bed. At the top of the column, the recycled liquid LR is mixed with the liquid SP. The means for recirculating the liquid 8 comprise a pump 9 for circulating the liquid. Furthermore, the exchange column CO is coupled to means for regenerating the liquid. The means for regenerating the liquid comprise a regeneration column 10, reboiling means 11, and a pump 16. The means for regenerating the liquid are arranged for regenerating a portion of the liquid circulating or not circulating in the means for recirculating the liquid 8: at the outlet of the pump 9, the liquid is separated into two branches, a first branch for recycling at the top of the exchange column CO, and the second for regeneration in the regeneration column 10. At the outlet of the column 10 and/or at the liquid outlet from the reboiling means 11, the liquid SP is injected at the top of the exchange column CO, for example by means of the pump 16.

FIG. 7 shows an exchange column CO comprising two packing beds 7. A gaseous fluid to be treated FA is introduced at the bottom of the exchange column CO, and the treated gaseous fluid FT is removed at the top of the exchange column CO. A liquid SP (for example a lean solvent within the context of an amine washing column) is injected at the top of the exchange column CO, and the liquid SR (rich solvent for the example of solvent) is removed at the bottom of the exchange column CO. The exchange column CO is equipped with means for recirculating the liquid 8. The means for recirculating the liquid 8 collect the liquid SR from the inter-bed zone, and reinject the recycled liquid LR at the top of the exchange column CO, above the upper packing bed. At the top of the exchange column CO, the recycled liquid LR is mixed with the liquid SP. The means for recirculating the liquid 8 comprise a pump 9 for circulating the liquid. Furthermore, the exchange column CO is coupled to means for regenerating the liquid. The means for regenerating the liquid comprise a regeneration column 10, reboiling means 11, and a pump 16. The means for regenerating the liquid are arranged for regenerating the liquid SR removed at the bottom of the exchange column CO. At the outlet of the regeneration column 10 and/or at the liquid outlet from the reboiling means 11, the liquid SP is injected at the top of the exchange column CO.

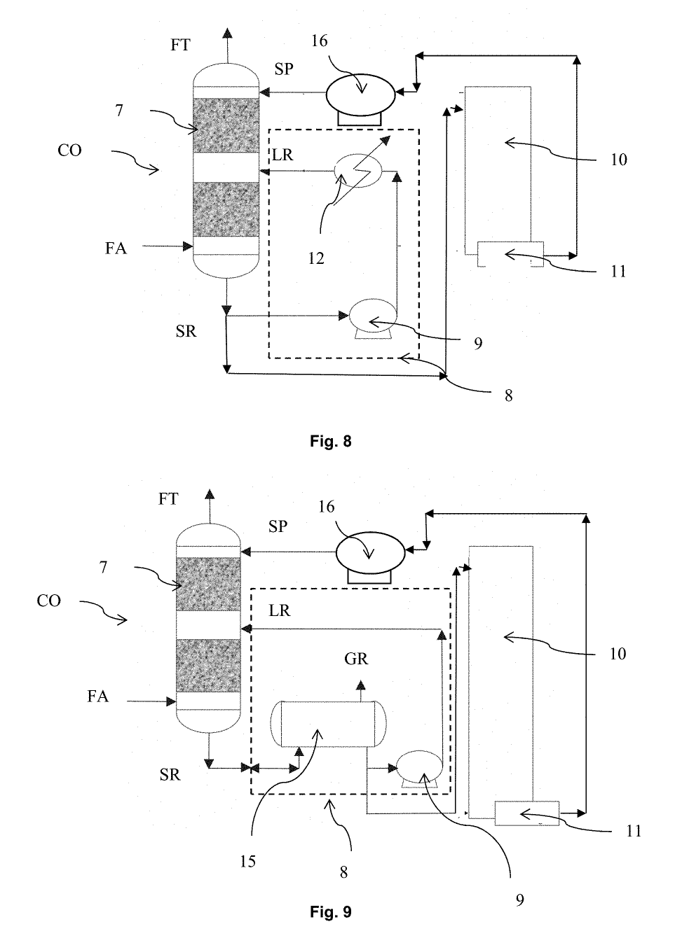

FIG. 8 shows an exchange column CO comprising two packing beds 7. A gaseous fluid to be treated FA is introduced at the bottom of the exchange column CO, and the treated gaseous fluid FT is removed at the top of the exchange column CO. A liquid SP (for example a lean solvent within the context of an amine washing column) is injected at the top of the exchange column CO, and the liquid SR (rich solvent for the example of solvent) is removed at the bottom of the exchange column CO. The exchange column CO is equipped with means for recirculating the liquid 8. The means for recirculating the liquid 8 collect the liquid SR at the bottom of the exchange column CO, and reinject the recycled liquid LR into an inter-packing bed zone. In the inter-packing bed zone, the recycled liquid LR is mixed with the liquid descending from the upper packing bed. The means for recirculating the liquid 8 comprise a pump 9 for circulating the liquid. In addition, the means for recirculating the liquid comprise a heat exchanger 12 to cool the liquid, and allow a better efficiency of the exchange column CO. Alternatively, the heat exchanger 12 can be provided to heat the liquid. Furthermore, the exchange column CO is coupled to means for regenerating the liquid. The means for regenerating the liquid comprise a regeneration column 10, reboiling means 11, and a pump 16. The means for regenerating the liquid are arranged for regenerating a portion of the liquid circulating in the means for recirculating the liquid 8: at the outlet of the pump 9, the liquid is separated into two branches, a first branch for cooling and recycling into the inter-packing bed zone, and the second for regeneration in the regeneration column 10. At the outlet of the regeneration column 10, the liquid SP is injected at the top of the exchange column CO, for example by means of the pump 16. Alternatively, to the embodiment shown in FIG. 7, the recycled and cooled (or heated) liquid LR can be injected at the top of the exchange column CO.

FIG. 9 shows an exchange column CO comprising two packing beds 7. A gaseous fluid to be treated FA is introduced at the bottom of the exchange column CO, and the treated gaseous fluid FT is removed at the top of the exchange column CO. A liquid SP (for example a lean solvent within the context of an amine washing column) is injected at the top of the exchange column CO, and the liquid SR (rich solvent for the example of solvent) is removed at the bottom of the exchange column CO. The exchange column CO is coupled to means for recirculating the liquid 8. The means for recirculating the liquid 8 collect the liquid SR at the bottom of the exchange column CO, and send it into a zone where the pressure is lower than the operating pressure of the exchange column CO, within a flash drum 15 where the dissolved gases are partially removed from the solvent under the effect of the expansion, and reinject a part of the semi-regenerated recycled liquid LR into an inter-packing bed zone. In the inter-packing bed zone, the semi-regenerated recycled liquid LR is mixed with the liquid descending from the upper packing bed. The means for recirculating the liquid 8 comprise a flash drum 15. The flash drum collects the liquid SR from the bottom of the exchange column CO and, by reducing the pressure with respect to the exchange column CO, allows a partial separation of the liquid from its load (for example gaseous). The flash drum 15 comprises a removal of the loads GR, for example of the rich gases (CO₂, H₂5). In addition, the means for recirculating the liquid comprise a pump 9 for circulating the liquid at the outlet of the flash drum 15. Furthermore, the exchange column CO is coupled to means for regenerating the liquid. The means for regenerating the liquid comprise a regeneration column 10, reboiling means 11, and a pump 16. The means for regenerating the liquid are arranged for regenerating a portion of the liquid circulating in the means for recirculating the liquid 8: at the outlet of the pump 9, the liquid is separated into two branches, a first branch for recycling into the inter-packing bed zone, and the second for regeneration in the regeneration column 10. At the outlet of the regeneration column 10, the liquid SP is injected at the top of the exchange column CO, for example by means of the pump 16. Alternatively, to the embodiment shown in FIG. 8, the partially regenerated recycled liquid LR can be injected at the top of the exchange column CO.

Other configurations can be envisaged. For example a heat exchanger 12 can be provided in the means for recirculating the liquid of one of the embodiments of FIG. 4 to 7 or 9. In addition, the embodiments of FIGS. 6 to 9 can be implemented without regeneration means 10, 11. According to other configurations, the regeneration means can be independent of the means for recirculating the liquid, in particular for the embodiments of FIGS. 5, 6, 8 and 9. Moreover, the liquid can be collected from several zones, for example both at the bottom of the column and from the inter-packing bed zone, then the liquid collected from several zones is mixed before being reinjected.

The recirculation means also improve the versatility of the exchange column. They allow a more compact design, in particular for the embodiment for which the distribution means are similar to those shown in FIG. 3. The means for distributing the liquid are dimensioned as a function of the minimum flow rate and the maximum flow rate. On the one hand, the number of orifices (or nozzles) in the horizontal tubes can be established as a function of the minimum flow rate (“turndown”), so as to ensure a homogeneous distribution of the liquid irrespective of the tilt angle of the exchange column. On the other hand, the height of the vertical pipe can be established as a function of the maximum flow rate in order to ensure the driving force necessary for removal of a greater flow rate through the orifices. In fact, given that the distribution means are unchanged (same number of orifices or nozzles in the horizontal tubes), the level of liquid increases in the vertical pipe in order to successfully achieve the removal of the liquid through the nozzles due to a greater height of liquid: the flow rate being greater through each orifice, with a proportionally higher velocity of fluid. The level of liquid in the vertical pipe effectively ensures the greatest driving force due to a greater mass of support, hence the greater flow rate through the orifices to the packing.

With the column according to the invention, a recirculation is established, which maintains a greater flow rate for the minimum flow rate. Thus, the ratio between the minimum and maximum flow rate for the invention is less than this same ratio for the prior art, in all the configurations envisaged and disclosed in FIGS. 4 to 9. It is thus possible to increase the number of orifices or nozzles in the horizontal tubes in order to ensure the minimum flow rate. Consequently, the height of liquid required to ensure the maximum flow rate is lower.

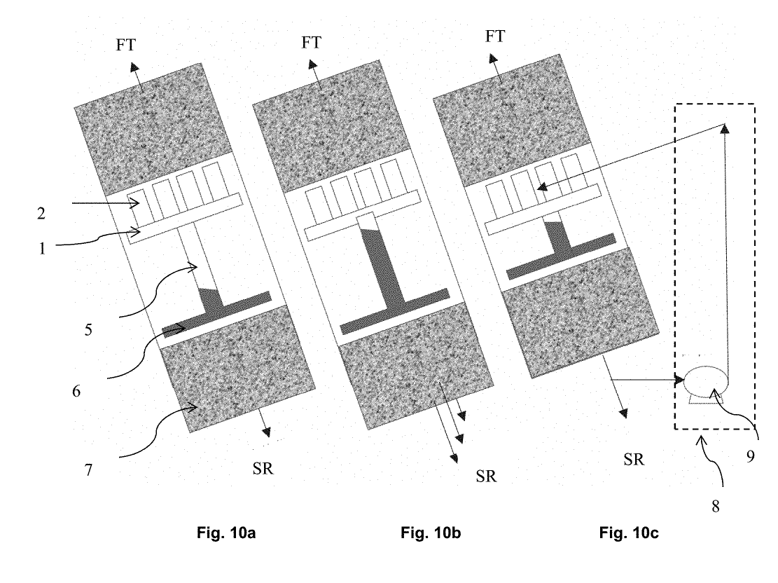

FIG. 10a shows a portion of exchange column according to the prior art, for the minimum flow rate (“turndown”) and for a tilt of the column. The column comprises two packing beds 7, a collector tray 1 equipped with chimneys 2 for the gas to pass through, and means for distributing the liquid. The means for distributing the liquid comprise a vertical pipe 5 and horizontal tubes 6. The treated gas FT is removed via the top of the column, and the liquid SR is removed via the bottom of the column. In the case of a low flow rate, little liquid (greyed part) is contained in the vertical pipe in order to ensure a homogeneous distribution through a number of orifices determined for this case.

FIG. 10b shows a portion of exchange column according to the prior art, for the maximum flow rate and for a tilt of the column (identical to the tilt in FIG. 10a). The column comprises two packing beds 7, a collector tray 1 equipped with chimneys 2 for the gas to pass through, and means for distributing the liquid. The means for distributing the liquid comprise a vertical pipe 5 and horizontal tubes 6. The treated gas FT is removed via the top of the column, and the liquid SR is removed via the bottom of the column. In the case of the maximum flow rate, a significant height of liquid (greyed part) is necessary in the vertical pipe in order to ensure a homogeneous distribution and a significant flow rate through the same number of orifices.

FIG. 10c shows a portion of exchange column according to the invention, for the maximum flow rate and for a tilt of the column (identical to the tilt in FIGS. 10a and 10b). The column comprises two packing beds 7, a collector tray 1 equipped with chimneys 2 for the gas to pass through, and means for distributing the liquid. The means for distributing the liquid comprise a vertical pipe 5 and horizontal tubes 6. The treated gas FT is removed via the top of the column, and the liquid SR is removed via the bottom of the column. In addition, the column is equipped with means for recirculating the liquid 8. The means for recirculating the liquid collect the liquid SR at the bottom of the column, and reinject it into the inter-packing bed zone above the collector tray 1. The means for recirculating the liquid 8 comprise a pump 9. Due to the recirculation of the liquid, the liquid flow rate is higher, in particular the minimum flow rate, therefore the height of the vertical pipe 5 can be reduced with respect to that shown in FIG. 10b.

It is thus possible to reduce the height of the means for distributing the liquid and to reduce the height of the exchange column. Thus, the exchange column is less high and less expensive.

The exchange column according to the invention is advantageously an amine washing column for removing the contaminants CO₂, H₂5 and/or COS from a natural gas but it is suitable for all types of solvents used in absorption.

The exchange column according to the invention is suitable for counter-current flows.

The exchange column according to the invention can be used in processes for the treatment of gas, capture of CO₂, distillation of liquid products, dehydration, separation from air, or exchange of heat. The column according to the invention can be used for offshore floating or land-based applications.

Moreover, the invention can quite particularly relate to floating barges or offshore platforms, for example of the FPSO (Floating Production, Storage and Offloading) type, or of the FLNG (Floating Liquefied Natural Gas) type. Distillation columns and/or dehydration columns using this device can also be installed on floating barges.

In the case of the processes for the treatment of gas and/or capture of CO₂, by means of an offshore floating column, the column according to the invention is in particular suitable for the following configurations:

The invention is particularly suitable for natural gases under high pressure with low acidic gas content (contaminant contents less than 2 mol. %). The flow rate determined in order to ensure the performance of the column is low (approximately from 10 to 30 m³/h/m² of column section) and the movements of the column by displacing the distribution of liquid can cause total drying out in the sections outside the packing section in the column. With the columns according to the prior art, at these points, there is a loss of overall efficiency of the absorption of the acid gases which are not in contact with the liquid which determines a poor performance of the exchange column. With a recirculation according to the invention, the average wetting rate is increased, dried-out zones are avoided, and purification is ensured at every point of the column section.

The invention is also suitable for natural gases under high pressure, the compositions and flow rates of which are very variable, or for the end-of-life conditions of a hydrocarbon deposit, because it makes it possible to avoid overdimensioning the height of the internal packing beds. In fact, the principle of a recirculation limits the overdimensioning of the systems for collecting and redistributing liquid by taking advantage of lower ratios between the maximum and minimum liquid flow rates, in order to obtain a more compact design of the distributors.

The invention is also suitable for gases that have a high CO₂ content or are polluted with significant quantities of aromatics and heavy hydrocarbons, noting that it is possible to combine the principle of recirculation with that of expansion (flash drum) under average pressure.

The invention is also suitable for gases with high COS contents (from 10 parts per million to 1000 parts per million) because the recirculation of liquid promotes the absorption of this contaminant which is absorbed slowly in amine solvents, and which usually requires significant quantities of liquid, noting that it is possible to combine the principle of recirculation with that of heating the recirculated solvent in order to accelerate the rate of absorption of the COS.

1) Column for the exchange of material and/or heat between a gas and a liquid comprising at least one packing bed (7), at least one collector tray (1) arranged above said packing bed (7), and means for distributing said liquid (4, 5, 6) over said packing bed (7). characterized in that said column (CO) is equipped with means for recirculating the liquid (8) from a zone situated below said packing bed (7) to a zone situated above said collector tray (1).

2) Column according to claim 1, in which said means for recirculating said liquid (8) comprise at least one pump (9).

3) Column according to claim 1, in which said means for recirculating said liquid (8) comprise at least one heat exchanger (12) for cooling or heating said liquid.

4) Column according to claim 1, in which said column (CO) is coupled to means for regenerating said liquid (10, 11).

5) Column according to claim 4, in which said means for regenerating said liquid (10, 11) are arranged in order to regenerate a portion of said liquid from said means for recirculating liquid (8).

6) Column according to claim 4, in which said means for regenerating receive a flow rate of said liquid (8) comprised between 20 and 200% of the flow rate of said liquid entering said column (CO).

7) Column according to claim 1, in which said means for recirculating the liquid (8) collect said liquid at the bottom of said column (CO).

8) Column according to claim 1, in which said column (CO) comprises a plurality of packing beds (7), a plurality of collector trays (1), and a plurality of distribution means (4, 5, 6).

9) Column according to claim 8, in which said means for recirculating said liquid (8) collect said liquid from a zone situated between two packing beds (7).

10) Column according to claim 8, in which said means for recirculating said liquid (8) convey said liquid in a zone situated between two packing beds (7).

11) Column according to claim 1, in which said means for recirculating said liquid (8) distribute said liquid at the top of said column (CO).

12) Column according to claim 1, in which said means for recirculating said liquid (8) comprise a flash drum (15) for regenerating said liquid.

13) Column according to claim 1, in which said distribution means comprise at least one vertical feed pipe (5) connected to said collector tray (1), and at least one substantially horizontal tube (6) connected to said feed pipe (5), said horizontal tube (5) comprising at least one orifice and/or one nozzle for the distribution of said liquid.

14) A process for the treatment of gas, capture of acidic gases, distillation, dehydration or separation of air which comprises conducting an exchange of material and/or heat between a gas and a liquid in a column according to claim 1.

15) A process for the treatment of a gas specifically comprising COS in addition to CO₂ and H₂S which comprises conducting an exchange of material and/or heat between a gas and a liquid in a column according to claim 1.
